(19) United States
(12) Patent Application Publication
(10) Pub. No.: US 2012/0194057 A1
(43) Pub. Date: Aug. 2, 2012

(54) ELECTRON EMITTING BODY AND X-RAY EMITTING DEVICE

(75) Inventors: Ryouichi Suzuki, Ibaraki (JP); Yoshihisa Ishiguro, Tokyo (JP); Masanori Haba, Tokyo (JP)

(73) Assignee: LIFE TECHNOLOGY RESEARCH INSTITUTE, Tokyo (JP)

(21) Appl. No.: 13/380,741

(22) PCT Filed: Feb. 23, 2010
(86) PCT No.: PCT/JP2010/001204

§ 371 Date: Apr. 15, 2012

(30) Foreign Application Priority Data
Jun. 24, 2009 (JP) JP2009-149991

(51) Int. Cl. H01J 1/14

(52) U.S. Cl. 313/346 R

(57) ABSTRACT

Provided are an electron emitting body having a high electron beam density and an X-ray emitting device embedding the electron emitting body. The electron emitting body has a substrate, the surface of which forms a concave surface, and a carbon film comprising a large number of projections made of carbon and expanded two-dimensionally. The carbon crystal grows such that first a swell portion (22) gradually becomes larger and then a needle-like portion (23) grows from the head of the swell portion (22). The needle-like portion (23) has a graphene sheet obliquely wound therearound in a multi-layer fashion and has a hollow inside. The axis of a carbon projection (21) thus formed is substantially orthogonal to a line tangent to the concave surface (11), so that the axes of a plurality of the carbon projections (21) intersect with each other at the focal point (F) of the concave surface (11).

### TECHNICAL FIELD

The present invention relates to an x-radiation device using an electron emission body (an emitter) and this electron emission body.

### BACKGROUND ART

The carbon nano-tube shown in patent document 1 and graphene sheet shown in patent document 2 are multilayered, and, as an electron emission body in vacuo to perform the field emission which an electric field is centralized, and releases an electron, the carbon film of a piled up tip shape is known.

Also, an electron emitting layer comprising the carbon nano-tube is formed in the substrate surface where a cathode electrode was formed, and an electron emitting layer and the electrically conductive layer of the electric potential are provided in the peripheral side outside this electron emitting layer, and, as structure to prevent an electronic direction released by an electron emission body from spreading, the structure that provided the gate electrode above of the electron emitting layer is further disclosed in patent document 3.

Also, the emitter in which the carbon nano-tube is oriented densely, and was formed so that the axis imitates the thickness direction of the substrate is disclosed in patent document 4 ion the surface of the substrate comprising silicon carbide single crystals.

Also, the electron emitting layer that responded to the shape of the recess by providing the recess in the surface contacting with the electron emitting layer of the glass substrate is formed, and subject matter to raise electronic convergence characteristics released from the electron emitting layer is disclosed in patent document 5.

Also, the gate electrode is provided the upward around emitter, and a lens electrode is located in the spaced-apart point from this gate electrode, and constitution to make electron beam released by an emitter converge with a lens electrode is disclosed in patent document 6.

### PRIOR ART

### Patented Documents

[patent document 1] Japanese Patent Laid-Open No. 2006-290,691 bulletin

[patent document 2] Japanese Patent Laid-Open No. 2008-150,253 bulletin

[patent document 3] Japanese Patent Laid-Open No. 2002-093307 bulletin

[patent document 4] Japanese Patent Laid-Open No. 2000-100,317 bulletin

[patent document 5] Japanese Patent Laid-Open No. 2002-100,282 bulletin

[patent document 6] Japanese Patent Laid-Open No. 2000-133,117 bulletin

### DISCLOSURE OF THE INVENTION

### Object of the Invention

Among the patent documents, there are some descriptions in patent document 3, 5 or 6 about preventing an electron beam emitted by an emitter (an electron emission body).

However, there is no description in patent document 3 and 5 about the conversion of the electron beam into one point. Their method is to restrain the expansion of the electron beam with gate electrodes, and not to raise electron beam density.

On the other hand, in patent document 6, there is a description about electron beam convergence using a lens electrode. However an electron beam emitted from a point-shaped emitter is radiated once, and then it converges with a lens electrode. This means that the radiated electron beam simply returns to the electron beam density. In this case, electron beam density is not increased.

Even more particularly, when it comes to a plane shaped emitter, it has some expansion e even if it makes an electron beam converge using a gate electrode and a lens electrode.

### MEANS FOR SOLVING THE PROBLEM

An electron emission body concerning the present invention was the electron emission body which formed the carbon film which released an electron by applying the voltage in to the surface of substrate, and it was said that the surface of the above substrate was concave to solve the problem, and the above carbon film was comprised of many carbon projections of different shapes formed on the surface of the film.

As the shape is concave, it is one which focuses on one point. In this case, the axis core of the projection lengthens towards an above focus.

For a projection comprising carbon, a preferable example is a projection comprising with the ridge which is formed in the substrate surface and a spiculum lengthening from the ridge. And the ridge has a hollow pillar on which a graphene sheet was wound in the spiral.

Also, it is preferable to provide the guard electrode on the fringe of the substrate.

This guard electrode projects higher than the carbon film, and the radius of curvature of the outer circumferential side is greater than a radius of curvature of the carbon film side.

Also, the composition of the x-radiation device concerning the present invention assumes the electron emission body as the cathode, and a metal target is assumed as an anode, and this anode is located at the concave focus position of the substrate.

### EFFECT OF THE INVENTION

Because an electron beam emitted by an emission face made in the form of a concave converges to one point, the electron beam density is increased in the electron emission body concerning the present invention.

When the substrate provides the guard electrode circumferentially, an electron beam can be further centralized.

Strong X-rays are emitted by a target to which the electron emission body is connected so that targets such as the cathode (cathodal), tungsten become the anode (anodal), and by placing a target at the focus position of the electron beam.

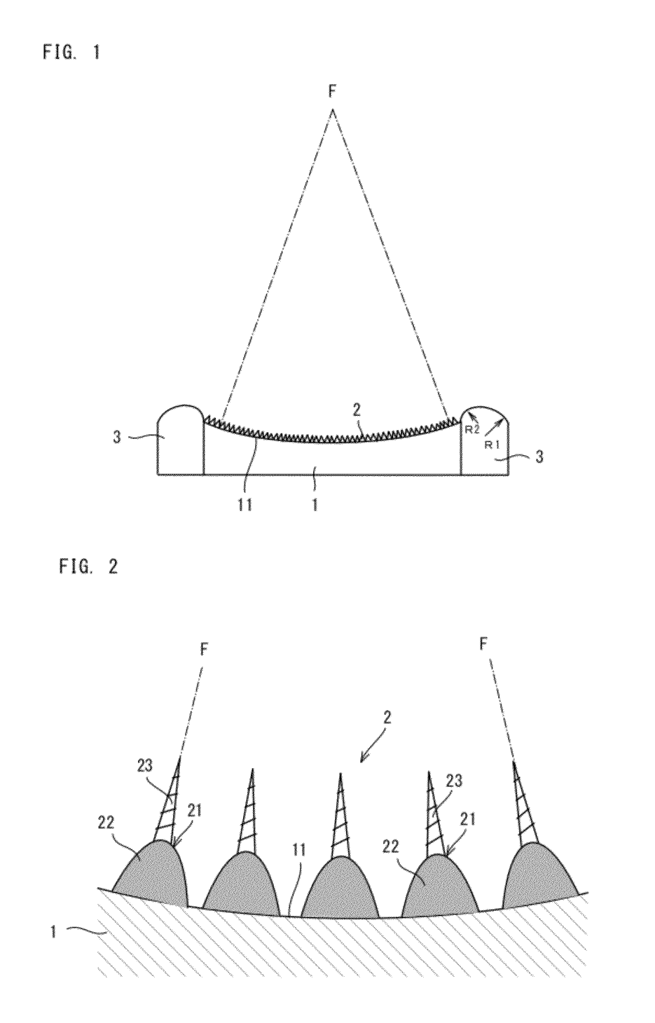

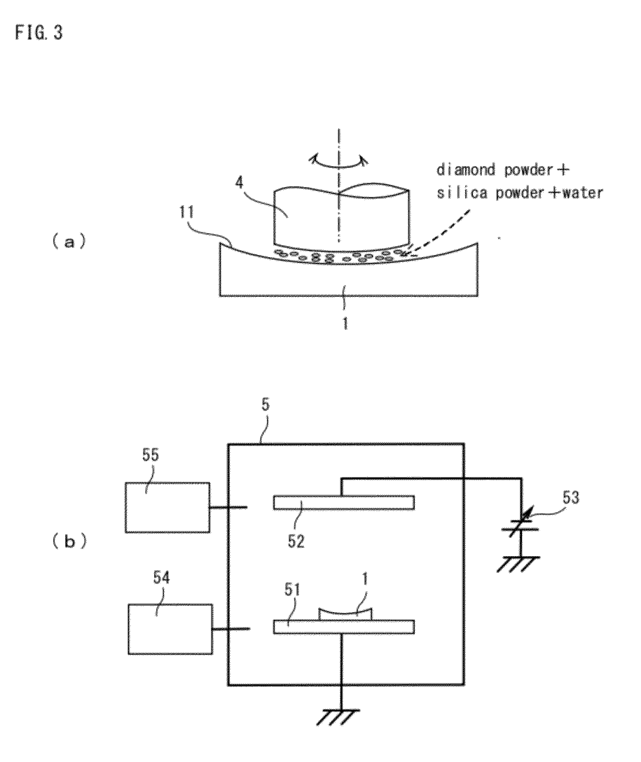

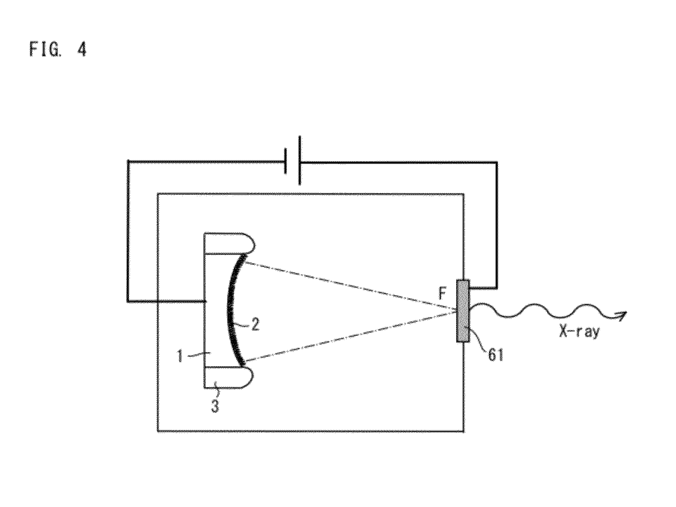

### BRIEF DESCRIPTION OF DRAWINGS

[FIG. 1] General view of the electron emission body concerning the present invention

[FIG. 2] Feature enlarged view of the electron emission body

[FIG. 3] Figure (a) and (b) describes an example of the formation method of the carbon film.

[FIG. 4] Schematic illustration of the x-radiation device which incorporated an electron emission body concerning the present invention.

### PREFERRED EMBODIMENT OF THE INVENTION

### Example

Preferred embodiment of the invention is described below based on the attached drawings.

As shown in FIG. 1, the electron emission body is comprised of a substrate 1 which is made from e.g. steel materials, carbon film 2 and ring shaped guard electrode 3.

The height of Ring-shaped guard electrode 3 projects higher than that of the carbon film 2 on the fringe of the substrate 1.

Also, the radius of curvature R1 of the peripheral side on the outside guard electrode 3 is set larger than the radius of curvature R2 of the carbon film 2 side.

The partial electric field concentration with carbon film 2 is restrained by assuming the shape of guard electrode 3 R1 is larger or equal to R2, and it can prevent current deterioration and electric discharge phenomenon with heat degradation.

A concave surface (a dent spherical surface) 11 is formed on substrate 1.

This concave surface 11 has a constant radius of curvature, and focus F for parallel incident rays if exist.

A carbon film 2 is formed with a thickness of a few micrometers to a few tens of micrometers on the concave surface 11.

As shown in FIG. 2, Large number of projections 21 are unfolds in the shape of a surface, and the projection 21 is constructed of a ridge 22 formed on the surface of the concave surface 11 and the spiculum 23 lengthening from this ridge 22.

A method to form the carbon film 2 is described based on FIG. 3.

As shown in FIG. 3(a), firstly the concave surface 11 is formed on the surface of substrate 1, then the concave surface 11 polished using a polishing stick 4.

A mixture of diamond powder, silica powder and water is used for the polishing.

Minute carbon particles or silica particles are attached to the surface of the concave surface 11 by the polishing, and these finer particles become the starting point for the growth of the carbon projection 21.

Then, as shown in shown in FIG. 3(b), the carbon film is layered using a parallel plate-shaped plasma CVD device 5.

Specifically, substrate 1 is set on electrode 51 of the bottom that is grounded so that concave surface 11 becomes the top, and the cathode side of DC power supply 53 is connected to upper electrode 52, and it grounds in the anode side.

And plasma CVD device 5 is exhausted with vacuum exhaust system 54, and hydrogen gas is introduced from gas introduction system 55, and internal pressure is slowly depressurized to 30 torr degree.

In this state, plasma is generated between electrode 51 and 52, and an electric current is increased up to around 2.5 A.

The oxidation film of the substrate surface is removed by this processing.

Then, mixed gases with hydrogen gas and methane gas is introduced in the plasma CVD device 5 from gas introduction system 55, and internal pressure force is slowly raised to 75 torr degree.

While maintaining this internal pressure, an electric current is slowly increased from 2.5 A to 6.0 A.

The electron of the plasma which occurred in plasma CVD device 5 collides with the methane gas, and the carbon atom is isolated, and the carbon atom is absorbed by the fine particles (carbon and silica) to become the seed of the crystalline on the surface of the concave surface 11, then the crystals of carbon grows slowly.

Gases such as Acetylene, ethylene, propane, or the steam of carbon monoxide, carbon dioxide, ethanol and organic solvent of acetone can be used besides methane for the reaction gas.

In the growing process of the carbon crystal, firstly ridge 22 grows up slowly and subsequently spiculum 23 grows starting from the tip of ridge 22.

This spiculum 23 has a hollow pillar on which a graphene sheet was wound in a spiral.

Since the axis of carbon projection 21 formed in this way, is perpendicular to a tangent line of the concave surface 11, the axis of a large number of carbon projections 21 will cross in focus F of the concave surface 11.

The electron emission body prepared by the above-mentioned method can be incorporated, for example, in an x-radiation device shown in FIG. 4.

That is, the x-radiation device inserts the electron emission body as the cathode (emitter) in case 6 with decompression condition (1-1000 torr), and a metal targets 61 such as tungsten is located at the position of focus F. This metal target 61 seals airtight into a case 6.

With the setting mentioned above, DC voltage is applied between substrate 1 as the cathode and metal target 61 as the anode. The current density of 100 mA/cm2 was measured instantly.

Then the strong electric field that is formed at the tip of the carbon projections 21, which comprise carbon film 2. A tunnel electron, estimated from a formula of Fowler-Nordheim, is released from the carbon 2 towards the metal target 61. Because it is released along an axis of carbon projection 21, as for this released electronic (an electron beam), an extremely high-density electron will collide to with the metal target 61 in focus F, and strong X-rays penetrate metal target 61 are generated.

As illustrated, it is a transmissive x-radiation device, in which electron beams are passing through the target, but it can also be a reflection type x-radiation device, in which electron beams generate X-rays by the reflection from the target.

### INDUSTRIAL APPLICABILITY

The x-radiation device which incorporated an electron emission body concerning the present invention and this electron emission body can be applied, for example, to Non Destructive Inspection apparatuses.

### DENOTATION OF REFERENCE NUMERALS

1 . . . A substrate, 11 . . . A concave surface of substrate, 2 . . . A carbon film, 21 . . . A projection to comprise carbon film, 22 . . . A ridge comprising projections, 23 . . . A spiculum which comprises projections, 3 . . . A guard electrode, 4 . . . A polishing stick, 5 . . . A plasma CVD device, 51, 52 . . . parallel plate electrodes, 53 . . . A DC power supply, 54 . . . vacuum exhaust system, 55 . . . gas introduction system, 61 . . . A metal target, R1 . . . A radius of curvature of the peripheral side, outside guard electrode, R2 . . . A radius of curvature of the carbon film side of the guard electrode, F . . . focus

What is claimed is:

1. An electron emission body having a carbon film formed on a surface of a substrate which releases an electron when a voltage is applied to the surface of the substrate, comprising:
the surface of the substrate is concave
the carbon film comprises a large number of projections composed of carbon in the shape of a plane,
a fringe of the substrate is provided with a guard electrode; and
the guard electrode projects higher than the carbon film, and radius of curvature of an outer circumferential side is bigger than radius of curvature of the carbon film side.

2. The electron emission body of claim 1, wherein:
the surface of the substrate is concave with one focal point; and
the axis cores of the projections are oriented to the direction of the focal point.

3. The electron emission body of claim 1, wherein:
the carbon projection is made from a ridge formed on the substrate surface and a spiculum growing from the ridge; and
the spiculum forms a hollow pillar on which a graphene sheet was wound in a spiral.

4. (canceled)

5. A cathode comprising of the electron emission body as claimed in claim 1, wherein:
A metal target is assumed as an anode; and
the anode is placed at the concave focus position of the concave substrate

6. A cathode comprising of the electron emission body as claimed in claim 2, wherein:
A metal target is assumed as an anode; and
the anode is placed at the concave focus position of the concave substrate.

7. A cathode comprising of the electron emission body as claimed in claim 3, wherein:
A metal target is assumed as an anode; and
the anode is placed at the concave focus position of the concave substrate.
